(19) United States
(12) Patent Application Publication
(10) Pub. No.: US 2008/0091818 A1
(43) Pub. Date: Apr. 17, 2008

(54) System And Method Of Employing Web Services Applications To Obtain Real-Time Information From Distributed Sources

(75) Inventors: David J. Bailey, Tampa, FL (US); Buddy Paul Murphy, Murrysville, PA (US)

Correspondence Address: AKERMAN SENTERFITT, P.O. BOX 3188, WEST PALM BEACH, FL, 33402-3188, US

(73) Assignee: RMB World Enterprises, LLC, Tampa, FL (US)

(21) Appl. No.: 11/548,568

(22) Filed: Oct. 11, 2006

(51) Int. Cl. G06F 15/173

(52) U.S. Cl. 709/224

(57) ABSTRACT

A system and method are provided that employ web service applications to obtain up-to-date information from a plurality of distributed sources in substantially real-time over a network. The system includes web service applications that reside at a plurality of distributed devices. One or more client terminal devices submit data requests, which are broadcast over the network to the plurality of distributed devices. The web service applications receive data requests and authenticate the source of the data request. If authenticated, the web service applications analyze the data request and retrieve information corresponding to the data request from the distributed devices. The retrieved information is forwarded to associated servers and merged into up-to-date reports or other documents.

### FIELD OF THE INVENTION

The invention relates to systems and methods of employing web service applications to obtain up-to-date information from distributed sources. More particularly, the invention relates to a distributed network of devices that are interconnected via a network and include web service applications, wherein the distributed network of devices process data requests in real-time to provide up-to-date information.

### BACKGROUND OF THE INVENTION

Known financial systems gather data using a centralized architecture. For example, existing credit bureaus periodically (i.e., monthly) receive credit information and other information from a plurality of third party credit granters. The credit information and other information is periodically delivered as data files to the credit bureaus on tapes and/or transferred periodically via electronic data transfer protocols. The data files are downloaded to a centralized database for storage and integration with other data in the centralized database. The data that is transferred is characterized by batches of records, which are defined between a finite time period, i.e. monthly or quarterly. The credit bureaus perform various tasks on the batches of records, including standardizing and logically matching disparate information to provide a consolidated record and creating an updated database of compiled records which is published as a new version that is available for the production of credit reports. A credit report is generated for selected accounts by associating numerous files, which are stored in the centralized database, with the selected account.

Existing credit reporting systems are deficient at least because credit information that is provided by third parties, which is used to generate the credit reports, does not include transactions and/or activities that occur between the periodic updates. The standardization process, the aggregation of data process, the exposure of data to multiple parties during data transfer, compromise data accuracy. Additionally, the volume of data that results from a master database build process exposes large batches of records and other data to security risks. Various other drawbacks exist with these known systems and with other systems known in the prior art.

### SUMMARY OF THE INVENTION

Various aspects of the invention overcome at least some of these and other drawbacks of existing systems. The invention provides systems and methods of employing web service applications and distributed architectures to capture various types of information, including transactions and/or activities, from distributed sources in substantially real-time.

According to one embodiment of the invention, servers may communicate with the plurality of remote sources by engaging web service applications that are located on the remote sources, via a network that supports web services. The web service applications that are located at the plurality of remote sources may authenticate the requestor and may scan respective databases for information that corresponds to the selected entities. The web service applications may return the search results, which are associated with the selected entities, to the distributed credit bureau.

According to one embodiment of the invention, entities may be selected for searching by using identifying information such as specific entity information, generalized criteria, or other identifying information. According to one embodiment, specific entity information may be used to search for specific entities by name, address, social security number, or other specific entity information. Generalized criteria may be used to search for entities that are defined by criteria, including data attributes, defined patterns and/or other criteria.

According to one embodiment of the invention, the search results may include up-to-date information that is associated with the searched entities, where up-to-date information may include information that was recorded at the plurality of remote sources immediately prior in time to submission of the search request. Thus, a credit report and/or other document may be generated for searched entities based on the up-to-date information. The credit reports may include an aggregation of information that is obtained from the distributed sources, including protected information, public record information, and/or other information. The credit reports may include on-line credit reports, printed credit reports, among other forms of credit reports.

According to one embodiment of the invention, the web server applications are installed in one or more distributed devices. The web service applications are activated and associated with servers of the distributed system. Client terminal devices are associated with the servers of the distributed system. A data request is obtained from the client terminal devices. The data request may be broadcast to the distributed devices. The web service applications receive the data request and authenticate the source of the data request. The authenticated data request is analyzed at the web service applications. Information corresponding to the data request is retrieved from the distributed devices. The retrieved information is forwarded to the servers of the distributed system. The servers of the distributed system merge the retrieved information to produce up-to-date reports or other documents. According to one embodiment, the reports may be on-line reports. According to another embodiment of the invention, an event may be triggered by the servers and forwarded to the client terminal devices and/or the distributed devices for processing.

The invention provides numerous advantages over and avoids many drawbacks of conventional systems. These and other objects, features, and advantages of the invention will be apparent through the detailed description of the embodiments and the drawings attached hereto. It is also to be understood that both the foregoing general description and the following detailed description are exemplary and not restrictive of the scope of the invention. Numerous other objects, features, and advantages of the invention should become apparent upon a reading of the following detailed description when taken in conjunction with the accompanying drawings, a brief description of which is included below.

### BRIEF DESCRIPTION OF THE DRAWINGS

The drawings appended hereto are intended to illustrate contemplated embodiments of the invention. The drawings are not intended to limit the invention solely to the embodiments illustrated and described.

FIG. 1 illustrates a system diagram according to one embodiment of the invention.

FIGS. 2A and 2B illustrate a flow chart for obtaining up-to-date information from a system according to one embodiment of the invention.

FIG. 3 illustrates a credit bureau system diagram according to one embodiment of the invention.

FIG. 4 illustrates a financial business intelligence system diagram according to one embodiment of the invention.

FIG. 5 illustrates a fraud data mining system diagram according to one embodiment of the invention.

FIG. 6 illustrates a homeland security system diagram according to one embodiment of the invention.

FIG. 7 illustrates a health care market analysis system diagram according to one embodiment of the invention.

FIG. 8 illustrates a medical record system diagram according to one embodiment of the invention.

FIG. 9 illustrates a credit request user interface according to one embodiment of the invention.

FIG. 10 illustrates a credit request user interface according to one embodiment of the invention.

FIG. 11 illustrates a credit request user interface according to another embodiment of the invention.

FIG. 12 illustrates a credit request user interface according to yet another embodiment of the invention.

FIG. 13 illustrates a search results user interface according to one embodiment of the invention.

FIGS. 14A-14C illustrate a credit report according to one embodiment of the invention.

### DETAILED DESCRIPTION OF THE INVENTION

The invention provides systems and methods of employing web service applications and a distributed architecture to capture various types of information, including transactions and/or activities, from distributed sources in substantially real-time. Existing systems, such as financial systems, employ a centralized architecture that includes a database for storing the financial information, including transactions and/or activities, wherein the financial information is updated by third parties on a periodic basis (i.e., monthly). The periodic updating of financial information introduces latency in capturing transactions and/or activities that occur between the periodic updates, thereby causing generation of incomplete financial information. Furthermore, existing systems that process incomplete information provide less accurate analytical results, including failing to identify correlations within information, providing deficient predictive statistical models, providing inferior pattern recognition results, and other drawbacks.

For example, in a conventional system employed by credit bureaus, a multitude of credit granters provide periodic (i.e., monthly) data updates to participating credit bureaus through tapes and/or other electronic media. The periodic data updates are stored in a database at the participating credit bureaus, wherein the database is searchable according to various metrics. A credit report is generated for individuals by matching a plurality of files or records that are extracted from the database and compiling the resulting data into a single file or record.

More particularly, in a conventional credit monitoring system, an entity may open a new credit card account with a credit grantor (such as a bank, insurance company, etc.) during a first week of a selected month. The credit grantor may send tapes and/or other electronic media that contain large volumes of data to participating credit bureaus at the end of each month, wherein the tapes and/or other electronic media identify activities (e.g., opening of a new account) and/or actions (e.g., payment amounts and/or account statuses (e.g., late payment or on-time payment)) that are recorded for various entities that are associated with the credit grantor.

Given the time lag between when an account is opened and when the account is reported to participating credit bureaus, the participating credit bureaus may not be aware of activities and/or actions that are associated with an entity until several weeks or months after the occurrence of the activities and/or the actions. The time lag may be extended longer due to internal processing at the credit bureau, including batching the information, standardizing the information, matching the information, and/or publishing the information, among other internal processing. Thus, any credit reports that are generated for entities may not be up-to-date when generated.

Furthermore, existing credit reporting systems suffer from other drawbacks including security risks that are associated with potentially misplacing/losing large volumes of confidential information that are stored on the tapes and/or the other electronic media, risks associated with compromising batched files and database repositories, delayed fraud detection based on analyzing out-of-date information, and other drawbacks. A system is needed that provides real-time information gathering to enable generation of accurate and up-to-date reports.

One solution involves using web service applications and distributed systems to access up-to-date information from a plurality of remote sources in substantially real-time over networks, such as the Internet or other networks. The remote sources may subscribe to a service that manages the web service applications for the distributed system. One exemplary remote source includes credit granters (i.e., credit authorizers, credit checkers, and credit clerks, etc.) that provide information on consumers, businesses and other entities, wherein the information includes account information for auto loans, mortgage loans and credit card accounts, such as payment history, payment amounts, payment time frames, aggregate balance information on debt value and asset value, among other information. The remote sources may download small modular software applications, or web service applications, that perform tasks on servers that are associated with the remote sources. An authorized credit requestor (i.e., credit card company, mortgage company, insurance company, dealer, broker, retailer etc.) may access a client terminal device and may request credit report information for an entity or group of entities through a distributed credit bureau, as described in this invention. According to one embodiment of the invention, authorized credit requestors that may request credit reports include entities defined by the Fair Credit Reporting Act.

According to one embodiment of the invention, the distributed credit bureau may communicate with the plurality of remote sources by engaging the web service applications via a network that supports web services. The web service applications that are located at the plurality of remote sources may authenticate the requestor and may scan respective databases for information that corresponds to the selected entities. The web service applications may return search results, which are associated with the selected entities, to the distributed credit bureaus.

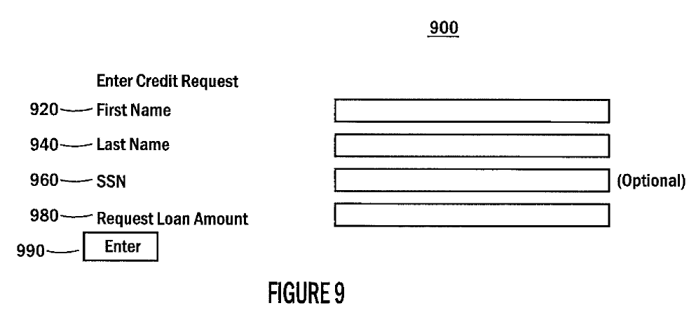

According to one embodiment of the invention, entities may be selected by using identifying information such as specific entity information, generalized criteria, or other identifying information. According to one embodiment illustrated in FIG. 9, users may access user interface 900 to conduct a search based on specific entity information. According to one embodiment, specific identifying information may include a first name 920, a last name 940, a social security number 960, a request loan amount 980, an address, and/or other specific entity information. Upon entry of the specific identifying information, an enter button may be selected to start the search process. One of ordinary skill in the art will readily recognize that other user interfaces may be employed and that other specific identifying information may be presented for search.

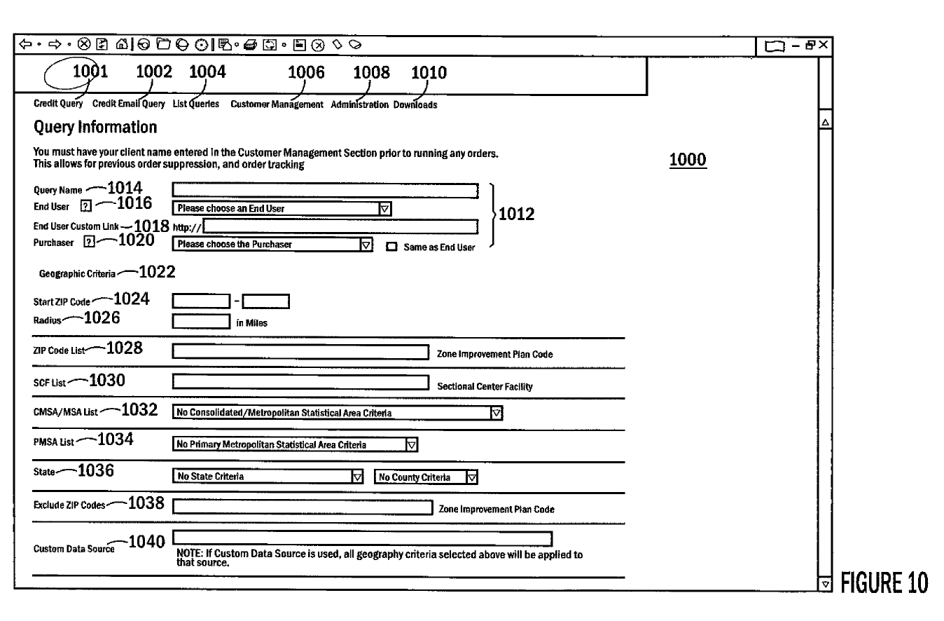

According to another embodiment of the invention, generalized criteria may be employed to search for entities that are defined by criteria, including data attributes, indexes, scorecards, defined patterns and/or other criteria. According an embodiment of the invention illustrated in FIG. 10, a generalized criteria user interface 1000 may include a plurality of tabs, including a credit query tab 1001, a credit email query tab 1002, a list queries tab 1004, a customer management tab 1006, an administration tab 1008, and/or a downloads tab 1010, among other tabs. According to one embodiment, the generalized criteria user interface 1000 may include a Customer Management section 1012 having a plurality of fields, including a query name field 1014, an end user field 1016, an end user customer link field 1018, and/or a purchaser field 1020, among other fields. According to one embodiment, the generalized criteria user interface 1000 may include a Geographic Criteria section 1022 having a plurality of fields, including start zip code field 1022 with an associated radius field 1026, a zone improvement plan code list field 1028, a sectional center facility list field 1030, a consolidated metropolitan statistical area criteria/metropolitan statistical area criteria list field 1032, a primary metropolitan statistical area criteria list field 1034, a state field 1036, an exclude zip codes field 1038, and/or a custom data source field 1040, among other fields. One of ordinary skill in the art will readily recognize that other user interfaces may be employed and that other generalized identifying information may be presented for search.

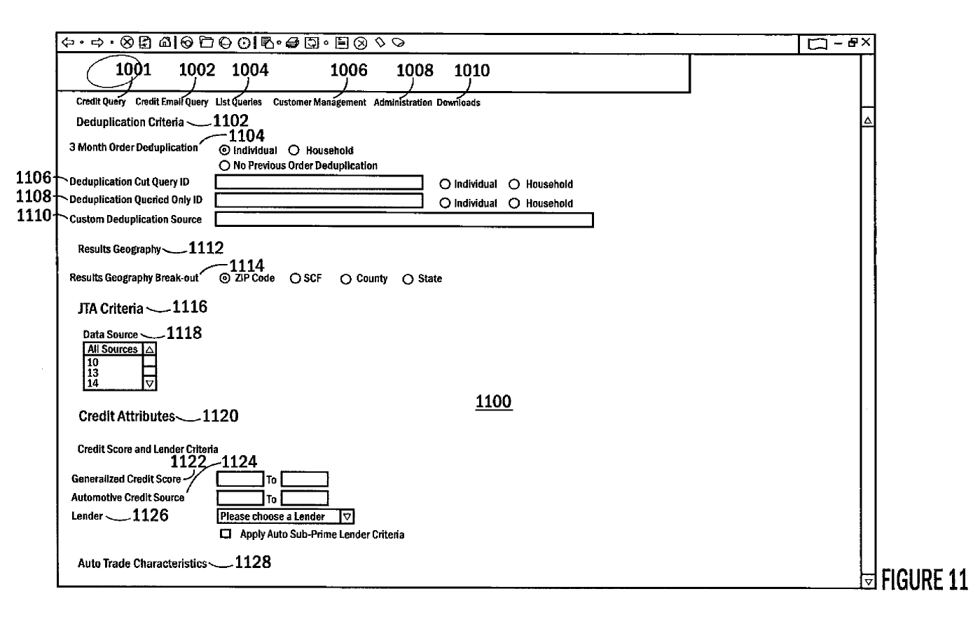

According to one embodiment illustrated in FIG. 11, the invention may include a second generalized criteria user interface 1100 having a Deduplication Criteria section 1102 with a plurality of fields, such as a three month order deduplication field 1104, a deduplication cut query identification field 1106, a deduplication queried only identification field 1108, and/or a custom deduplication source 1110, among other fields. According to another embodiment, the second generalized criteria user interface 1100 may further include a Results Geography section 1112 that includes a results geography break-out field 114, among other fields. According to another embodiment, the second generalized criteria user interface 1100 may further include a JTA Criteria section 1116 that includes a data source selection area 1118. According to another embodiment, the second generalized criteria user interface 1100 may further include a Credit Attributes section 1120 that includes a generalized credit score field 1122, an automotive credit score field 1124, and/or a lender field 1126, among other fields. According to another embodiment, the second generalized criteria user interface 1100 may further include an Auto Trade Characteristics section 1128 having one or more fields. One of ordinary skill in the art will readily recognize that other user interfaces may be employed and that other generalized identifying information may be presented for search.

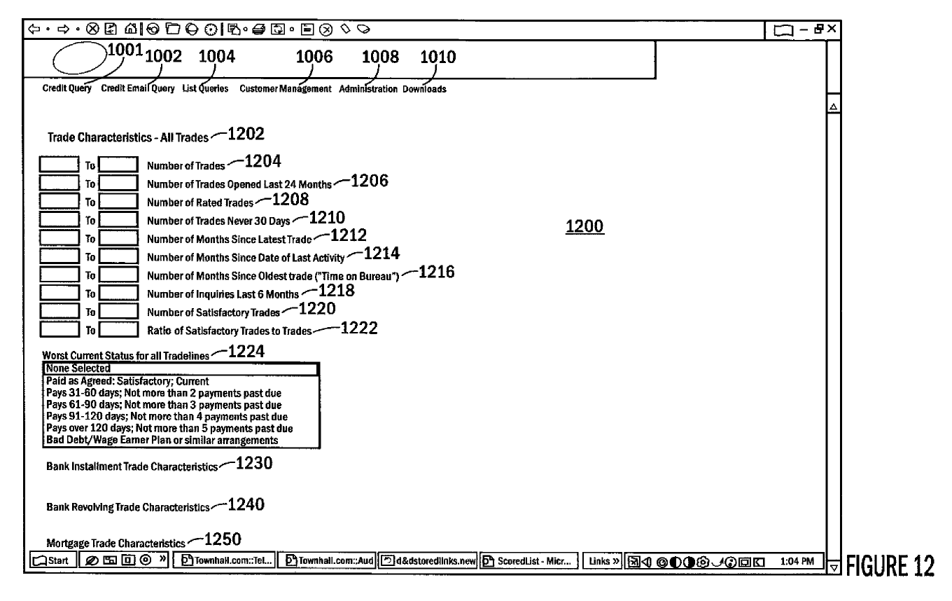

According to another embodiment illustrated in FIG. 12, the invention may include a third generalized criteria user interface 1200 having a Trade Characteristics—All Trades section 1202 with a plurality of fields, such a number of trades field 1204, a number of trades opened last 24 months field 1206, a number of rated trades field 1208, a number of trades over 30 days field 1210, a number of months since latest trade field 1212, a number of months since date of last activity field 1214, a number of months since oldest trade (“time in bureau”) field 1216, a number of inquiries last 6 months field 1218, a number of satisfactory trades field 1220, and/or a ratio of satisfactory trades to trades field 1222, among other fields. According to another embodiment, the Trade Characteristics—All Trades section 1202 may include a worst current status of all tradelines selection area 1224. According to another embodiment, the third generalized criteria user interface 1200 may further include a Bank Installment Trade Characteristics section 1230, a Bank Revolving Trade Characteristics section 1240 and/or a Mortgage Trade Characteristics section 1250 having one or more fields. One of ordinary skill in the art will readily recognize that other user interfaces may be employed and that other generalized identifying information may be presented for search.

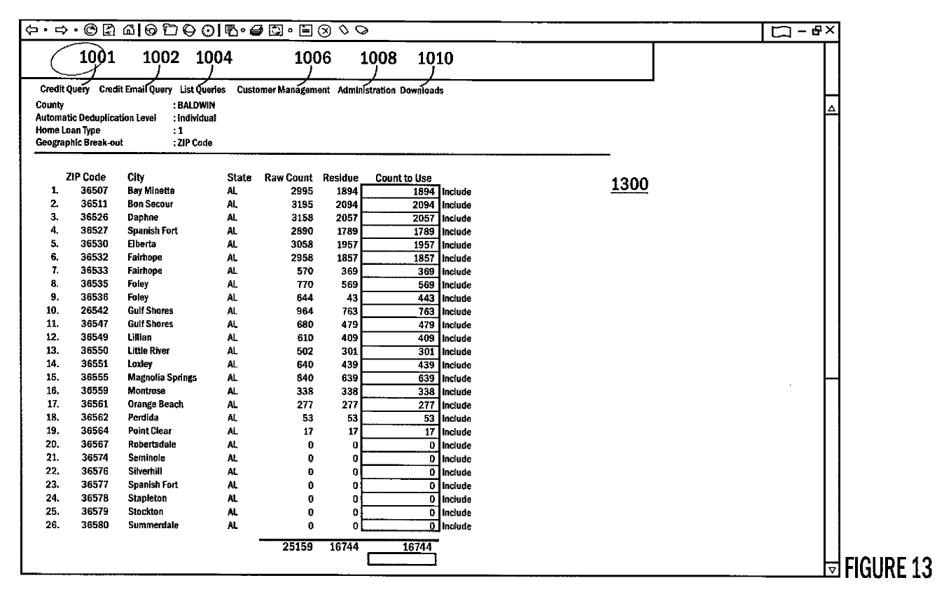

According to one embodiment, the invention may present search results for identifying information such as specific entity information, generalized criteria, or other identifying information, that includes up-to-date information that is associated with the searched entities, wherein up-to-date information may include information that was recorded at the plurality of remote sources immediately prior in time to submission of the search request. FIG. 13 illustrates a screen-shot of a search result user interface 1300 according to one embodiment of the invention that is presented based on a zip code geographic breakout. The layout structure of search result user interface 1300 is deemed to be self explanatory, therefore the various search results do not include reference numbers along with explanations. One of ordinary skill in the art will readily recognize that other user interfaces may be employed and that other information may be presented.

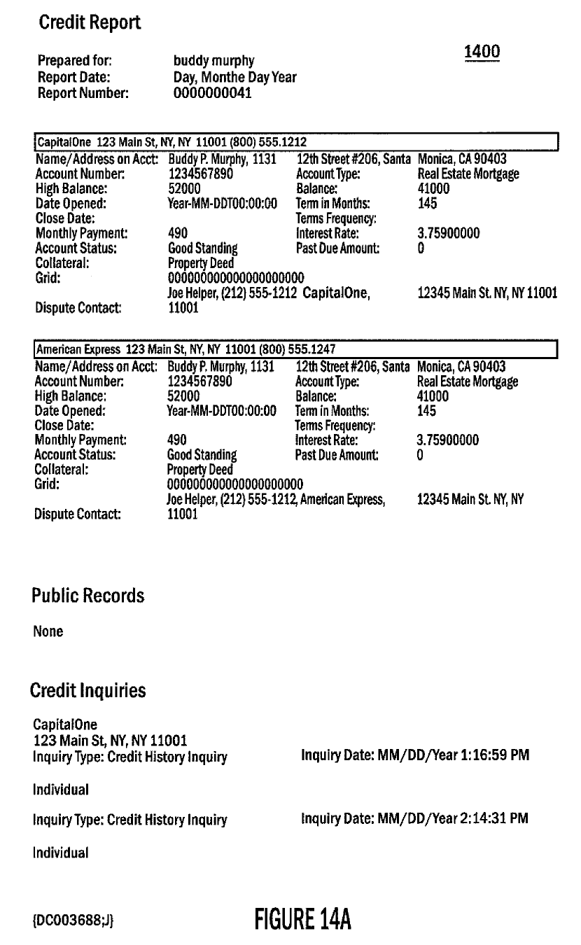

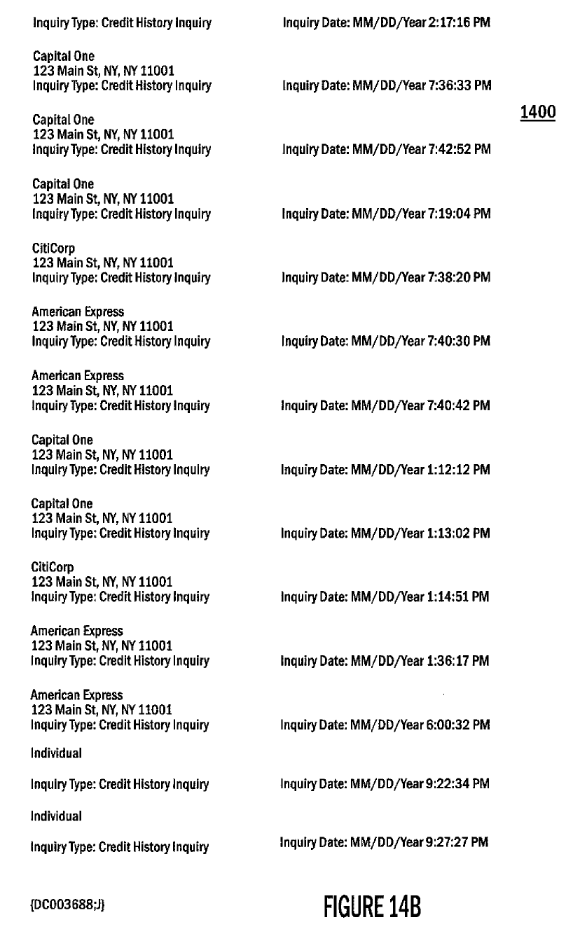

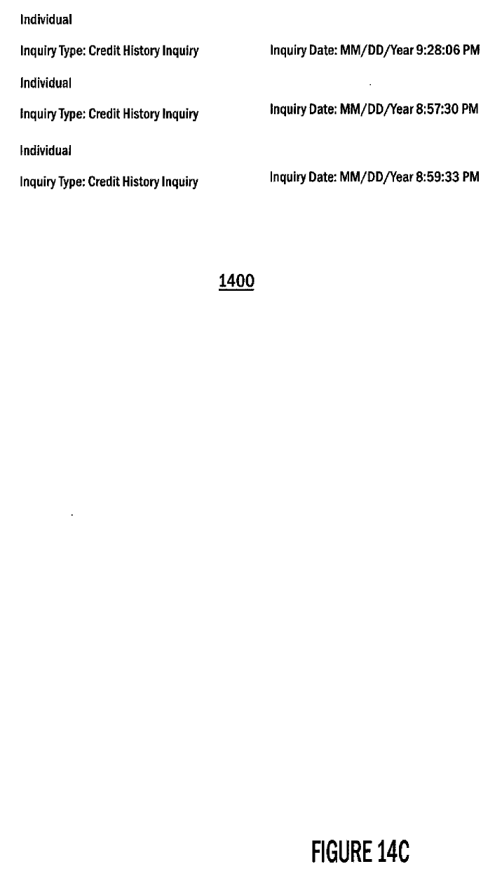

According to another embodiment of the invention, a credit report and/or other document may be generated for searched entities based on the up-to-date information. FIGS. 14A-14C illustrate screen-shots of a credit report user interface 1400 according to one embodiment of the invention. The layout structure of credit report user interface 1400 is deemed to be self explanatory, therefore the various sections do not include reference numbers along with explanations. The credit reports include an aggregation of the information that is obtained from the distributed sources, in protected information, public record information, and/or other information. The credit reports may include on-line credit reports, printed credit reports, among other forms of credit reports. According to another embodiment of the invention, information may be transfer to internal credit systems or external (e.g., third party) credit systems that may combine additional sources of information to display combined credit decision support information.

The invention provides several advantages over existing systems that use a centralized architecture, including enabling access to up-to-date data in substantially real-time; reducing risks of loss for high volume data that is stored on memory devices; retrieving data from a native source to improve data accuracy; enabling real-time fraud detection based on analyzing up-to-date data; providing transparent usage logs that identify data, requesting parties, remote sources and other information associated with the data; and significantly reducing costs, among other advantages.

While specific embodiments of the invention are discussed herein and are illustrated in the drawings appended hereto, the invention encompasses a broader spectrum than the specific subject matter described and illustrated. For example, the embodiments described herein are directed to credit reporting systems, fraud detection systems, national intelligence systems, data mining systems, health care systems, and medical record systems, among other systems. However, the invention applies to various other systems. As would be appreciated by those skilled in the art, the embodiments described herein provide but a few examples of the broad scope of the invention. There is no intention to limit the scope of the invention only to the embodiments and/or systems described herein.

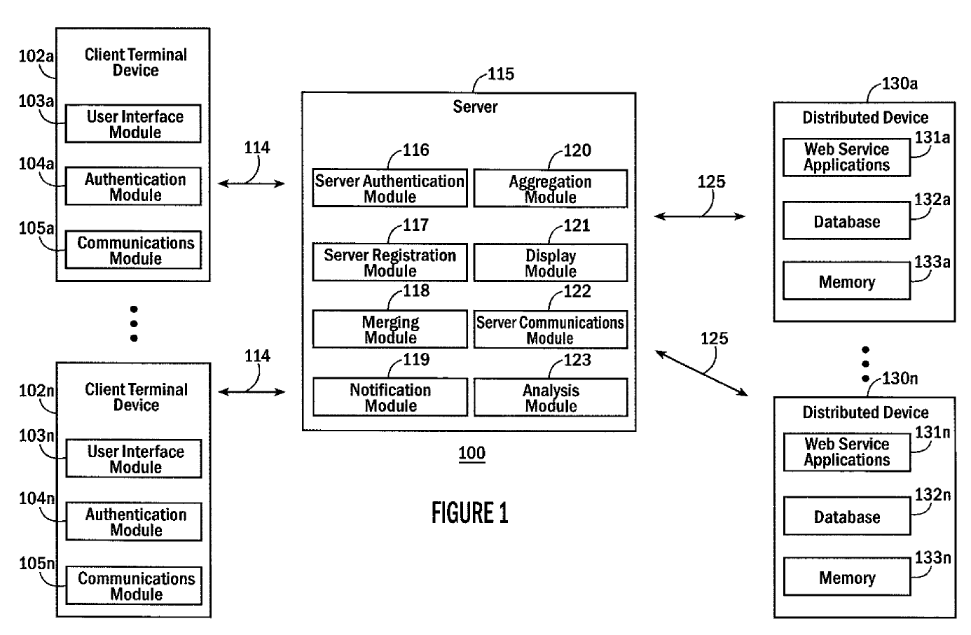

Widespread use of computer networks, effective increases in bandwidth, increases in processing power, web-based transactions, and the adoption of web services as a standard for intranet communications and internet communications offer great potential for information gathering and dissemination, both as an enabling infrastructure and as a platform for supporting new applications. FIG. 1 illustrates an example of the system architecture 100 according to one embodiment of the invention. According to one embodiment, the client terminal devices 102a-102n (hereinafter client terminal devices 102), one or more servers 115, and the distributed devices 130a-130n (hereinafter distributed devices 130) may be connected via a wired media, a wireless media, or a combination of the foregoing. According to one embodiment of the invention, terminal devices 102, servers 115, and distributed devices 130 may reside in one or more networks, such as an internet, an intranet, or a combination thereof

According to one embodiment of the invention, the client terminal devices 102 may include any number of different types of client terminal devices, such as personal computers, laptops, smart terminals, personal digital assistants (PDAs), cell phones, portable processing devices that combine the functionality of one or more of the foregoing or other client terminal devices.

According to another embodiment of the invention, the client terminal devices 102 may include several components, including processors, RAM, a USB interface, a telephone interface, microphones, speakers, a stylus, a computer mouse, a wide area network interface, local area network interfaces, hard disk drives, wireless communication interfaces, DVD/CD readers/burners, a keyboard, a flat touch-screen display, a computer display, and/or other components. According to yet another embodiment of the invention, client terminal devices 102 may include, or be modified to include, software that may operate to provide data gathering and data exchange functionality.

According to one embodiment of the invention, the client terminal devices 102, the servers 115, and/or the distributed devices 130 may include several modules. The modular construction facilitates adding, deleting, updating and/or amending modules therein and/or features within modules. The client terminal devices 102 may include various modules, including a user interface module 103, an authentication module 104, a communications module 105 and/or other modules. The servers 115 may include various modules, including a server authentication module 116, a server registration module 117, a merging module 118, a notification module 119, an aggregation module 120, a display module 121, a server communication module 122, a modeling or analysis module 123, and/or other modules. It should be readily understood that a greater or lesser number of modules might be used. One skilled in the art will readily appreciate that the invention may be implemented using individual modules, a single module that incorporates the features of two or more separately described modules, individual software programs, and/or a single software program.

According to one embodiment of the invention, the client terminal devices 102 may communicate through web browser applications. According to another embodiment, the user interface modules 103a-103n (hereinafter user interface modules 103) may support several interfaces including display screens, voice recognition systems, speakers, microphones, input buttons, and/or other interfaces. According to one embodiment of the invention, the user interface modules 103 may display the web browser application on a user interface associated with the client terminal device 102. According to one embodiment of the invention, select functions may be implemented through the client terminal device 102 by positioning an indicator over selected icons and manipulating an input receiving device, such as a mouse, a keyboard, or other input receiving devices. According to another embodiment of the invention, select functions may be implemented through the client terminal device 102 using a voice recognition system to enable hands-free operation. According to yet another embodiment of the invention, the client terminal devices 102 may include a touch-sensitive display screen that is combined with an audio input device, such as a voice recognition system.

With regard to user authentication, the authentication modules 104a-104n (hereinafter user authentication modules 104) may employ one of several different authentication schemes, as would be appreciated by those skilled in the art. According to one embodiment of the invention, the user authentication modules 104 may prompt users to input alphanumeric code or other identifying information. According to another embodiment of the invention, the user authentication modules 104 may prompt users to provide biometric information (i.e., a thumbprint through a fingerprint scanner) or other suitable identifying information. If the user is not identified, then the user may be invited to resubmit the requested identification information or to take other action.

According to one embodiment of the invention, the client terminal devices 102 may include communication modules 105a-105n (hereinafter communication modules 105) for enabling the client terminal devices 102 to communicate with systems, including other client terminal devices, the servers 115, the distributed devices 130 and/or other systems. The client terminal devices 102 may communicate via communications media 114 and 125 such as, for example, any wired and/or wireless media. Communications between the client terminal devices 102, the distributed devices 130 and the servers 115 may occur substantially in real-time, when the devices are coupled to the network. According to one embodiment of the invention, the communications module 105 may communicate with the servers 115 to exchange data, wherein the data exchange may occur with or without user awareness of the data exchange.

According to an alternative embodiment of the invention, communications may be delayed for an amount of time if, for example, one or more client terminal devices 102, server 115, and/or distributed devices 130 arc not coupled to the network. According to one embodiment of the invention, any requests that are submitted while the client terminal devices 102 and/or distributed devices 130 are not coupled to the network may be stored and propagated from/to the offline client terminal devices 102 and/or distributed devices 130 when the target client terminal devices 102 and/or distributed devices 130 are re-coupled to the network. One of ordinary skill in the art will appreciate that communications may be conducted in various ways and among various devices.

According to one embodiment of the invention, user authentication information and/or identification information may be forwarded to the servers 115 to perform various functions. According to another embodiment of the invention, servers 115 may operate as a web service hub to coordinate communications between the web service applications that are associated with the client terminal devices 102 and the distributed devices 130.

According to one embodiment of the invention, a server authentication module 116 may be associated with the servers 115 to receive authentication information that is entered into a corresponding client terminal device 102 via the authentication modules 104. The server authentication module 116 may compare the identifying information with existing records and operate as a gatekeeper to the system 100. If the user is determined to be a registered user, the authentication module 116 may attempt to authenticate the registered user by matching the entered authentication information with access information that exists on the servers 115. If the user is not authenticated, then the user may be invited to resubmit the requested identifying information or take other action. If the user is authenticated, then the servers 115 may perform other processing. For example, the client terminal devices 102 may receive information from the servers 115 and/or from another authenticated client terminal device.

According to one embodiment of the invention, a server registration module 117 may be associated with the servers 115 to register a new user. If, at login, the user is online and a determination is made that the user has not previously registered, then the user may be provided with a registration user interface to prompt the user to register. Requested registration information may include, for example, user name, corporate name, address, identification number, telephone number, and/or other registration information. Following receipt of the registration information and after performing a verification process, the server registration module 117 may add the user to the list of authorized users.

According to one embodiment of the invention, the distributed devices 130 may include any number of different types of distributed devices, such as servers, personal computers, laptops, smart terminals, or other distributed devices. According to another embodiment of the invention, the distributed devices 130 may include several components, including processors, RAM, a USB interface, a telephone interface, microphones, speakers, a stylus, a computer mouse, a wide area network interface, local area network interfaces, hard disk drives, wireless communication interfaces, a keyboard, a flat touch-screen display, a computer display, and/or other components.

According to one embodiment of the invention, the distributed devices 130 may include, or be modified to include, the web service applications 131a-131n (hereinafter web service applications 131), databases 132a-132n (hereinafter databases 132) and memory 133a-133n (hereinafter memory 133). The web service applications 131 may operate to provide data gathering and data exchange functionality. According to one embodiment of the invention, the invention may enable tracking of data communication across a network. For example, the web service applications 131 may associate an internet protocol (IP) address, or other identifying information, of the distributed devices 130 with data that is provided by the distributed devices 130. According to one embodiment of the invention, the data tracking features may be employed to generate usage logs. According to one embodiment of the invention, usage logs may be produced to provide transparency for transactions. For example, the web service applications 131 may provide data identifying requester information, distributed device information, data elements that were obtained from the distributed devices 130, royalty information associated with retrieved information, and other identifying data. According to one embodiment of the invention, the identifying data may be provided in real-time. According to another embodiment of the invention, the identifying data may be employed in fraud detection.

According to one embodiment, the web service applications 131 may be operated on a subscription basis. In other words, web service applications 131 may be remotely activated and remotely deactivated based on payment of a subscription fee or other compensation.

According to one embodiment of the invention, the web service applications 131 may include a monitoring feature that monitors communication between the servers 115 and the distributed devices 130. According to one embodiment of the invention, the web service applications 131 may monitor data packets that traverse communications lines 125, wherein the data packets may include identification markers. According to another embodiment of the invention, the web service applications 131 may scan the data packets for predetermined identification markers that are associated with servers 115 or other known source. The web service applications 131 may capture, in real-time, data packets having the predetermined identification markers.

According to one embodiment of the invention, the captured data packets may be analyzed and authenticated using known techniques. After authentication, information may be extracted from the data packets. The extracted information may include data requests that correspond to selected entities that are associated with the distributed devices 130. According to one embodiment of the invention, a security protocol may be used to secure the data exchange. For example, a token may be transmitted over a secure socket layer (SSL) connection that is encrypted with triple data encryption standard (DES). The distributed devices 130 may verify the request with a call-back that provides reciprocal verification. According to another embodiment of the invention, additional security may be provided by limiting a range of IP addresses that are recognized.

According to one embodiment of the invention, the information that is extracted from data that is received from the servers 115 may be used to search databases 132 or other data structures that are associated with the distributed devices 130 for data that corresponds to the selected entities. The search may be performed using a variety of techniques. According to one embodiment, the search may be performed using a structured query language (SQL) that uses SQL statements to perform tasks on the databases 132, such as retrieving data from the databases 132. According to one embodiment of the invention, the data retrieved from the databases 132 of the associated distributed device 130 may be limited to data corresponding to the selected entities.

According to one embodiment of the invention, the servers 115 may communicate with the distributed devices 130 to initiate forwarding of data retrieved from the databases 132. According to one embodiment of the invention, the data retrieved from the databases 132 may be forwarded to the servers 115 at a time when the data is obtained, in essentially real-time, or at a time thereafter. According to another embodiment of the invention, the web service applications 131 may initiate forwarding of the retrieved data to the servers 115 or other devices.

According to another embodiment of the invention, the data retrieved from the database 132 may be stored locally at the corresponding distributed devices 130 and may be distributed to servers 115 after occurrence of pre-determined criteria, including passage of a pre-determined amount of time, accumulation of a pre-determined amount of data, occurrence of an event and/or other predetermined criteria. According to one embodiment of the invention, the data retrieved from the database 132 may be batched at the distributed devices 130 in a temporary memory 133 or other data storage device.

According to one embodiment of the invention, the servers 115 may include a merging module 118 that merges the data retrieved from the distributed devices 130. According to one embodiment, matching logic may provide rules that define how data is combined from the distributed devices 130. The retrieved data may be merged into categories based criteria, such as entity information, creditor information, date, and/or other criteria. The merged information may be used to generate up-to-date documents, including online documents, credit reports and other documents.

According to another embodiment of the invention, the servers 115 may include a notification module 119 that generates notifications and/or alerts. According to one embodiment, the notification module 119 may generate and forward notifications to client terminal devices 102 and/or to the distributed devices 130 upon receipt of information by the servers 115. For example, the notifications may include reports of items, such as a listing of data elements that were requested from distributed devices 130, a listing of data elements that were retrieved from distributed devices 130, an identity of the requester, a compensation amount that will be paid for the requested data, and/or other items. According to another embodiment, the notification module 119 may generate notifications that are provided to the distributed devices 130 advising of activation or impending deactivation of the web service applications 131 based on a payment or failure to pay a subscription fee.

According to one embodiment of the invention, the servers 115 may include an aggregation module 120 that aggregates data received from the distributed devices 130. According to one embodiment of the invention, the aggregation module 120 may compile the data received from the distributed devices 130. According to another embodiment of the invention, the aggregation module 120 may compile the data received from the distributed devices 130 in essentially real-time. According to another embodiment, numerical functions such as the sum total of all occurrences of particular inputted criteria for all or a selected group of distributed devices may be performed. For example, the numeric sum total of open mortgage accounts of distributed devices (or banks) in a selected geographic area, during a particular interval of time may be provided. This module may produce simple or more complex aggregations. According to another embodiment, the aggregation module may compare the total of open mortgage accounts of distributed devices defined above with another selected group of distributed devices (or banks) from another geographic region or time period and may calculate percent deviations in one or many selected geographic regions.

According to one embodiment of the invention, a minimal amount of the data that is retrieved from the distributed devices 130 may be stored at the servers 115. In other words, the servers 115 may perform data gathering and/or document generating functions and may thereafter purge all or portions of the retrieved data. As a result, according to one embodiment, the invention may minimize security risks associated with exposing any confidential retrieved data to unauthorized parties at the servers 115. According to another embodiment of the invention, the retrieved data may be stored at the servers 115 for a predetermined amount of time before being purged. According to yet another embodiment of the invention, public record information, non-confidential retrieved data, and/or tracking information, such as activity log files associated with an entity, may be stored at the server 115.

According to one embodiment of the invention, the servers 115 may include a display module 121 that displays data received from the client terminal devices 102 and/or the distributed devices 130. According to one embodiment of the invention, the display module 120 may display the data received from the client terminal devices 102 and/or the distributed devices 130 in real-time. According to one embodiment of the invention, the display module may provide a ticker-type data display that change dynamically in time similar to how conventional systems display the value of a particular company's stock. According to one embodiment of the invention, only authorized selected parameters and criteria may be displayed. For example, the aggregation module may determine percentages that are calculated in selected geographic regions during a selected time interval, but the display module may only display the geographic area or criteria that exceed a select defined deviation. In another embodiment of the invention, only particular client devices or distributed devices may received privileges to access a particular displays of data. In another embodiment of the invention, only an exception report may be displayed.

According to one embodiment of the invention, the servers 115 may include a server communications module 122 for enabling the servers 115 to communicate with systems, including other client terminal devices 102, other servers 115, the distributed devices 130 and/or other systems. The servers 115 may communicate via communications media 114 and 125 such as, for example, any wired and/or wireless media. Communications between the client terminal devices 102, the distributed devices 130 and the servers 115 may occur substantially in real-time, when the devices are coupled to the network. According to one embodiment of the invention, the server communications module 122 may communicate with the client terminal devices 102 to exchange data, wherein the data exchange may occur with or without user awareness of the data exchange.

According to an alternative embodiment of the invention, communications may be delayed for an amount of time if, for example, one or more client terminal devices 102, server 115, and/or distributed devices 130 are not coupled to the network. According to one embodiment of the invention, any requests that are submitted while the client terminal devices 102 and/or distributed devices 130 are not coupled to the network may be stored and propagated from/to the offline client terminal devices 102 and/or distributed devices 130 when the target client terminal devices 102 and/or distributed devices 130 are re-coupled to the network. One of ordinary skill in the art will appreciate that communications may be conducted in various ways and among various devices.

According to one embodiment of the invention, the servers 115 may include an analysis module 123 that generates search queries, performs calculations and analyzes data received from the client terminal devices 102 and/or the distributed devices 130. According to one embodiment of the invention, the analysis module 123 may receive an input string from the client terminal devices 102 and may generate a search query that is forwarded to the distributed devices 130. Alternatively, the search query may be generated at the client terminal device and forwarded to the distributed devices 130 via servers 115. According to one embodiment of the invention, calculations may include predefined functions; dynamic algorithms that are based on communications from the client terminal devices 102 and/or the distributed devices 130; genetic algorithms; machine learning algorithms; and/or other calculations. According to one embodiment of the invention, the analysis module 123 may perform the calculations and may analyze the data received from the client terminal devices 102 and/or the distributed devices 130 in real-time.

According to another embodiment of the invention, the selected entities may be actively monitored through placement of the selected entities on a watch list. According to one embodiment of the invention, the selected entities may be monitored based on features, such as data attributes, patterns and/or other features. According to one embodiment of the invention, the web service applications 130 may alert servers 115 when information in databases 132 is updated for selected entities that are placed on the watch list. Upon receipt of the alert, the server 115 may perform actions, such as notifying a predetermined client device 102 that is associated with a department, such a fraud department or other department.

According to another embodiment of the invention, the client devices 102 that are associated with enforcement departments, such as police departments, federal agencies or other departments, may be notified of suspicious activity. Communication with the enforcement departments may be occur within a credit bureau network or may occur outside the credit bureau network. According to one embodiment of the invention, the notifications and/or the alerts may be communicated over wired or wireless media 114, 125. The notifications and/or alerts may be generated based on various triggers.

According to one embodiment of the invention, the server 115 may generate the notifications and/or alerts in real-time. The generated notifications and/or alerts may be delivered in real-time. Alternatively, the notifications and/or alerts may be delivered after a pre-determined delay. The notifications and/or alerts may be delivered using known communication techniques including electronic mail, mobile telephones, telephone messages, text messages, instant messages, and other communication techniques. The notifications and/or alerts may be delivered through the client terminal devices 102, the distributed devices 130, or other communication devices including cell phones, personal digital assistants (PDAs) that are linked to the client terminal devices 102 and/or the distributed devices 130.

FIG. 1 is provided for illustrative purposes only and should not be considered limitations of the invention. Other configurations will be appreciated by those skilled in the art and are intended to be encompassed by the invention.

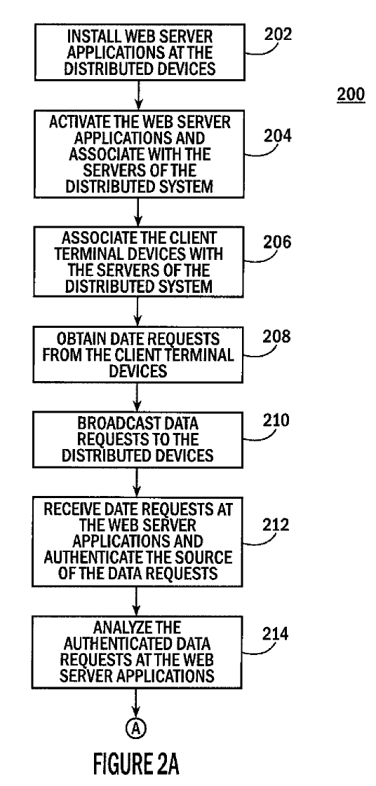

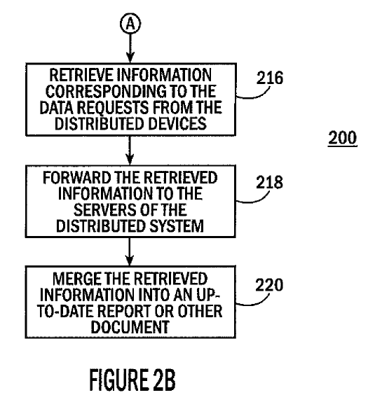

FIGS. 2A and 2B illustrate a method of obtaining up-to-date information from a plurality of distributed devices. In operation 202, the web server applications 131 are installed in one or more distributed devices 130. In operation 204, the web service applications 131 are activated and associated with servers 115 of a distributed system. In operation 206, client terminal devices 102 are associated with the servers 115 of the distributed system. In operation 208, a data request is obtained from the client terminal devices 102. In operation 210, the data request is broadcast to the distributed devices 130. In operation 212, the web service applications 131 receive the data request and authenticate the source of the data request. In operation 214, the authenticated data request is analyzed at the web service applications 131. In operation 216, information corresponding to the data request is retrieved from the distributed devices 130. In operation 218, the retrieved information is forwarded to the servers 115 of the distributed system. In operation 220, the servers 115 of the distributed system merge the retrieved information to produce an up-to-date reports or other documents. According to one embodiment, the reports may be an on-line reports. According to another embodiment of the invention, an event may be triggered by the servers 115 and forwarded to the client terminal devices 102 and/or distributed devices 130 for processing.

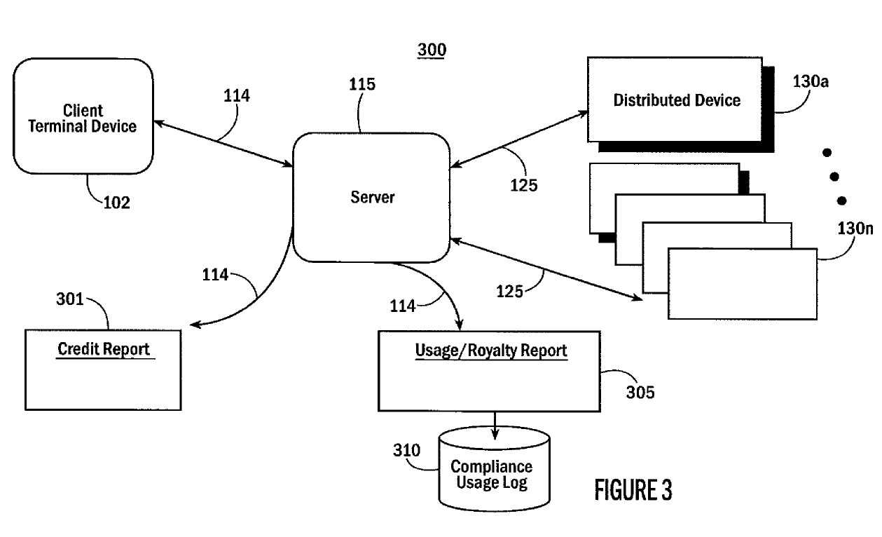

FIGS. 3-8 illustrate exemplary embodiments of the invention as applied to various uses. For the purpose of simplifying the illustrations, the client terminal devices 102, the servers 115 and the distributed devices 130 are illustrated without the various modules. However, it is readily understood that the client terminal devices 102, the servers 115 and the distributed devices 130 may include the corresponding modules described above.

FIG. 3 illustrates an exemplary embodiment of the invention as applied to a distributed credit bureau system 300. According to one embodiment of the invention, the system may operate as described above. According to one embodiment of the invention, the client terminal devices 102 may be accessed by requesters including, credit granters, insurance companies, dealers, brokers, retailers and/or other requesters. According to one embodiment of the invention, the distributed devices 130 may provide data that includes transactions, payments, balances, delinquencies, and history among other data. Server 115 may generate credit reports 301. The credit reports may include an aggregation of the information that is obtained from the distributed sources, including protected information, public record information, and/or other information. The credit reports 301 may include on-line credit reports, printed credit reports, and/or other types of credit reports. According to one embodiment of the invention, server 115 may generate usage logs and/or royalty reports 305. The usage log reports 305 may maintain a record that associates a credit requestor with a credit grantor and may identify any accessed information. The royalty report 305 may provide a listing of compensation that is due to various parties for accessing the information. According to one embodiment of the invention, compliance usage log 310 may be generated for auditing purposes and may include information to comply with federal guidelines. One of ordinary skill in the art will readily appreciate that the invention may generate other output, including reports and logs or may access other connections.

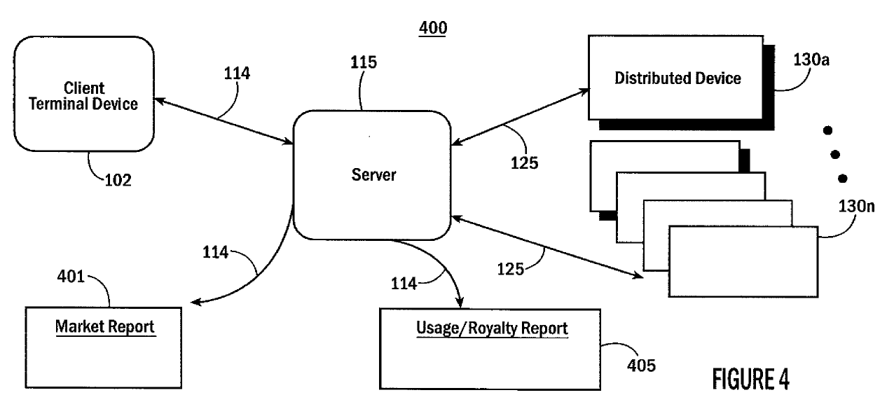

FIG. 4 illustrates an exemplary embodiment of the invention as applied to a financial business intelligence system 400. According to one embodiment of the invention, the system may operate as described above. According to one embodiment of the invention, the client terminal devices 102 may be accessed by requesters including credit granters, insurance companies, dealers, brokers, retailers and/or other requesters. According to one embodiment of the invention, the distributed devices 130 may provide data that includes transactions, payments, balances, delinquencies, and history among other data. Server 115 may generate market reports 400. The market reports 401 may include an aggregation of the information that is obtained from the distributed sources, including protected information, public record information, and/or other information. The market reports 401 may include on-line market reports, printed market reports, and/or other types of market reports. According to one embodiment of the invention, server 115 may generate usage logs and/or royalty reports 405. The usage log reports 405 may maintain a record that associates a credit requestor with a credit grantor and may identify any accessed information. The royalty report 405 may provide a listing of compensation that is due to various parties for accessing the information. One of ordinary skill in the art will readily appreciate that the invention may generate other output, including reports and logs or may access other connections.

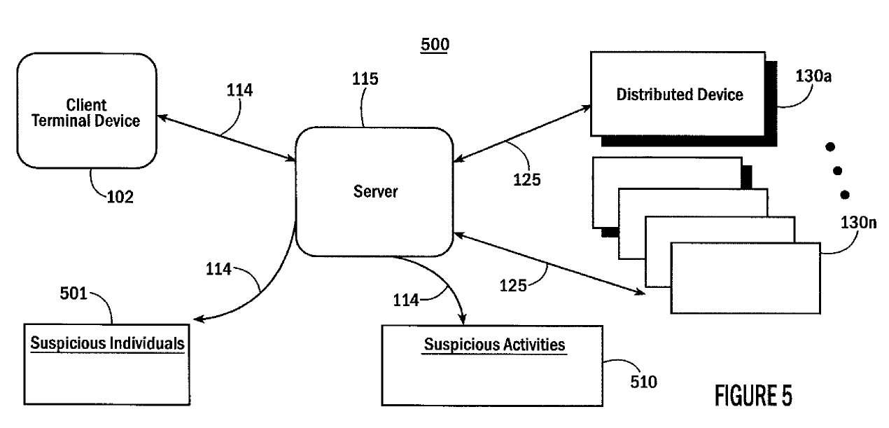

FIG. 5 illustrates an exemplary embodiment of the invention as applied to a fraud data mining system 500. According to one embodiment of the invention, the system may operate as described above. According to one embodiment of the invention, the client terminal devices 102 may be accessed by requestors including, banks, credit card issuers, the Federal Bureau of Investigations and/or other requestors. According to one embodiment of the invention, the distributed devices 130 may provide data that includes banking transactions, payments, balances, open accounts, dates, and history, among other data. Server 115 may generate suspicious individual reports 501. The suspicious individual reports may include a listing of suspicious individuals that are identified through information obtained from the distributed sources, including protected information, public record information, and/or other information. The suspicious individual reports 501 may include on-line suspicious individual reports, printed suspicious individual reports, and/or other types of suspicious individual reports. According to one embodiment of the invention, server 115 may generate a listing of suspicious activity reports 510. The suspicious activity reports 510 may maintain a record associating activities performed by credit requestors and/or credit grantors. A threshold level of activity may be established and compared to activities performed by credit requesters and/or credit grantors in order to trigger suspicious activity alerts. One of ordinary skill in the art will readily appreciate that the invention may generate other output, including reports and logs or may access other connections.

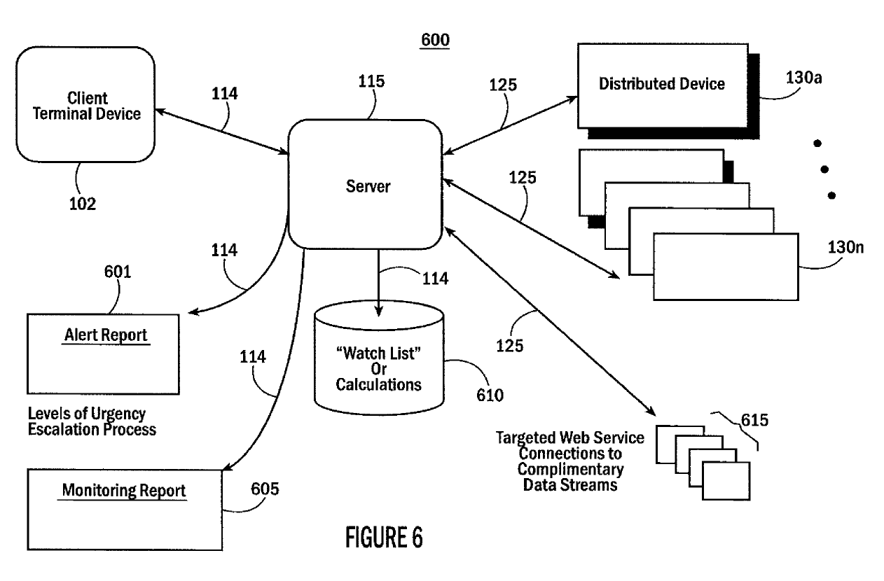

FIG. 6 illustrates an exemplary embodiment of the invention as applied to a homeland security system 600. According to one embodiment of the invention, the system may operate as described above. According to one embodiment of the invention, the client terminal devices 102 may be accessed by requesters including federal agencies, such as the Department of Homeland Security, the National Intelligence Agency, and/or other requestors. According to one embodiment of the invention, the distributed devices 130 may provide data that includes credit data, banking transactions, payments, balances, open accounts, dates, and history, among other data. Server 115 may generate alert reports 601 and/or monitoring reports 605. The alert reports 600 may include a listing of suspicious activities that are identified through information obtained from the distributed sources, including protected information, public record information, and/or other information. The alert reports 601 and monitoring reports 605 may include on-line reports, printed reports, and/or other types of reports. According to one embodiment of the invention, server 115 may generate a watch list or calculation reports 610. The watch list or calculation reports 610 may maintain a record associating activities performed by credit requestors and/or credit grantors. A threshold level of activity may be established and compared to activities performed by credit requesters and/or credit grantors in order to trigger watch list or calculation reports 610. According to another embodiment of the invention, the server 115 may access targeted web service connections to complementary data streams 615. One of ordinary skill in the art will readily appreciate that the invention may generate other output, including reports and logs, or may access other connections.

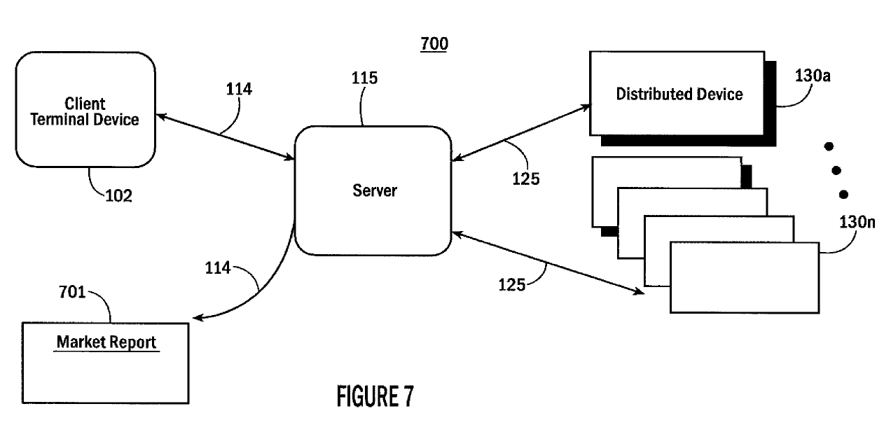

FIG. 7 illustrates an exemplary embodiment of the invention as applied to a health care market analysis system 700. According to one embodiment of the invention, the system may operate as described above. According to one embodiment of the invention, the client terminal devices 102 may be accessed by requesters including insurance companies, health maintenance organizations (HMOs), pharmaceutical companies, and/or other requesters. According to one embodiment of the invention, the distributed devices 130 may provide data that includes health problem lists, prescription drug lists, doctor comments and history, among other data. Server 115 may generate market reports 701. The market reports 701 may include an aggregation of the information that is obtained from the distributed sources, including protected information, public record information, and/or other information. The market reports 701 may include on-line market reports, printed market reports, and/or other types of market reports. One of ordinary skill in the art will readily appreciate that the invention may generate other output, including reports and logs or may access other connections.

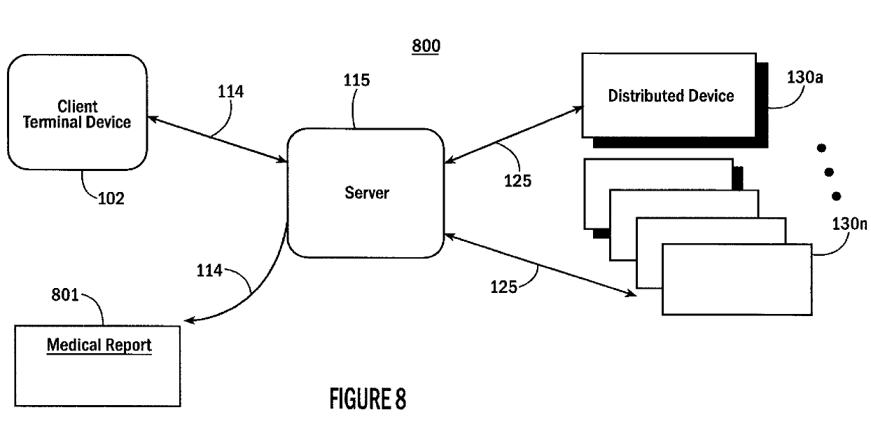

FIG. 8 illustrates an exemplary embodiment of the invention as applied to a medical record system 800. According to one embodiment of the invention, the system may operate as described above. According to one embodiment of the invention, the client terminal devices 102 may be accessed by requesters including insurance companies, health maintenance organizations (HMOs), doctor, patient and/or other requesters. According to one embodiment of the invention, the distributed devices 130 may provide data that includes health problem lists, prescription drug lists, doctor comments, and history, among other data. Server 115 may generate medical reports 801. The medical reports 801 may include an aggregation of the information that is obtained from the distributed sources, including protected information, public record information, and/or other information. The medical reports 801 may include on-line medical reports, printed medical reports, and/or other types of medical reports. One of ordinary skill in the art will readily appreciate that the invention may generate other output, including reports and logs or may access other connections.

While the preferred forms of the invention have been disclosed, it will be apparent to those skilled in the art that various changes and modifications may be made that will achieve some of the advantages of the invention without departing from the spirit and scope of the invention. It will be apparent to those reasonably skilled in the art that other components performing the same function may be suitably substituted. Further, the methods of the invention may be achieved in either all software implementations, using the appropriate processor instructions, or in hybrid implementations that utilize a combination of hardware logic and software logic to achieve the same results. Therefore, the scope of the invention is to be determined solely by the appended claims.

We claim:

1. A network communication system for obtaining up-to-date information from a plurality of sources, comprising:
a server; and
a plurality of distributed devices that communicate with the server, the plurality of distributed devices comprising:
a data source; and
a web services application that monitors data packets received from the server for predetermined identification markers, extracts information from the data packets having the predetermined identification markers, performs a search of the data source, and forwards search results to the server,
wherein the server communicates with the plurality of distributed devices to initiate forwarding of the search results to the server.

2. The network communications system according to claim 1, wherein the web services applications operate in substantially real-time to monitor data packets received from the server for predetermined identification markers, extract information from the data packets having the predetermined identification markers, perform a search of the data source, and forward search results to the server.

3. The network communications system according to claim 1, wherein the server receives search results from two or more of the plurality of distributed devices.

4. The network communications system according to claim 3, wherein the server includes a merging module that merges the search results received from two or more of the plurality of distributed devices.

5. The network communications system according to claim 4, wherein the merging module merges the search results into categories based on selected criteria.

6. The network communications system according to claim 1, wherein the web service application generates tracking information by associating identifying information from the corresponding distributed device and the search results obtained from the corresponding distributed device.

7. The network communications system according to claim 6, wherein the server generates a usage log based on the tracking information.

8. The network communications system according to claim 1, wherein the web service application authenticates the data packets received from the server before performing the search of the data source.

9. The network communications system according to claim 3, wherein the server generates a report that includes information from the search results received from two or more of the plurality of distributed devices.

10. The network communications system according to claim 1, wherein the server and the plurality of distributed devices are provided in an intranet or internet environment.

11. A network communication system for obtaining up-to-date information from a plurality of sources, comprising:
a server;
a plurality of terminal devices that communicate with the server; and
a plurality of distributed devices that communicate with the server, the plurality of distributed devices comprising:
a data source; and
a web services application that monitors data packets received from the server for predetermined identification markers, extracts information from the data packets having the predetermined identification markers, performs a search of the data source, and forwards search results to the server,
wherein the server communicates with the plurality of distributed devices to initiate forwarding of the search results to the server.

12. The network communications system according to claim 11, wherein the plurality of terminal devices are configured to generate a search request that is forwarded to the server.

13. The network communications system according to claim 11, wherein the server, the plurality of terminal devices and the plurality of distributed devices are provided in an intranet or internet environment.

14. A method of obtaining up-to-date information from a plurality of sources, comprising:
installing web service applications on a plurality of distributed devices;
activating the web service applications;
associating the web service applications with a server;
broadcasting a search request from the server to the plurality of distributed devices, wherein the search request includes data packets having predetermined identification markers;
analyzing the predetermined identification markers at the web service applications;
enabling the web service applications to perform a search on a data source associated with a corresponding one of the plurality of distributed devices if the data packets include the predetermined identification markers;
enabling the server to communicate with the plurality of distributed devices to initiate forwarding of the search results; and
forwarding search results to the server.

15. The method according to claim 14, wherein analyzing the predetermined identification markers at the web service applications is performed in substantially real-time.

16. The method according to claim 15, further comprising merging the forwarded search results from two or more of the plurality of distributed devices.

17. The method according to claim 15, further comprising associating identifying information from the corresponding distributed device and the search results obtained from the corresponding distributed device to generate tracking information.

18. The method according to claim 17, further comprising generating a usage log based on the tracking information.

19. The method according to claim 15, further comprising authenticating the data packets received from the server before performing the search of the data source.

20. The method according to claim 15, wherein the distributed devices and the server communicate in an intranet or internet environment.
